(19) United States
(12) Patent Application Publication
(10) Pub. No.: US 2007/0166140 A1
(43) Pub. Date: Jul. 19, 2007

(54) Specialized mobile equipment handling lift system

(76) Inventor: Jerry G. Warthan, Arlington, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 11/333,651

(22) Filed: Jan. 17, 2006

(51) Int. Cl. B60P 1/64

(52) U.S. Cl. 414/498

(57) ABSTRACT

A cargo handling assembly for use with a mobile vehicle including a base frame which is capable of being mounted on the floor of the vehicle. The base frame has a pair of parallel spaced rail members. A carriage assembly having a pair of spaced parallel extension arms can be slidably advanced and retracted along the rail members. An opposing wheel arrangement, mounted on each extension arm, creates an opening for receiving a length of each parallel spaced rail member, whereby the carriage assembly is horizontally translatable along the length of the base frame by movement of the opposing wheels along the spaced rail members. A load cage is connected to the carriage by an actuator mechanism for rotating the load cage in an elliptical path about an rotational axis between a first position, where the cage is disposed in a substantially horizontal position and lies in nested relation relative to the base frame, and a second position, in which the cage is disposed in a substantially vertical position with respect to a surrounding support surface.

### BACKGROUND OF THE INVENTION

1. Field of the Invention

The present invention relates to an equipment handling lift system which can be mounted in the cargo region of a standard-sized passenger van, a minivan, or other similarly designed vehicle, and which can load and unload bulky, heavy equipment safely and efficiently.

2. Description of Prior Art

There are various examples in the prior art of cargo handling assemblies which are used for loading or unloading cargo from various overland vehicles such as railroad cars, automobiles, trucks and the like. In most cases, the devices of the prior art required fairly drastic modification of the overland vehicles in order to render the devices operational. Additionally, the prior art devices tended to be unduly complicated in design and cumbersome in nature, making the designs somewhat expensive to manufacture and difficult to install and maintain.

Certain of the prior art designs, while acceptable for specific intended purposes, nevertheless required the operator to expend substantial amounts of strength to load or unload the cargo. In many cases, these known designs failed to orient the cargo in an appropriate position for ease of handling. While this may have been acceptable in the case of unloading groceries or retail stock or similar applications, such designs were not acceptable for loading and unloading heavier and bulkier items, such as, for example, medical diagnostic equipment. In the case of, for example, medical imaging equipment, there was the additional need to provide adequate protection for such expensive and delicate equipment during the loading and unloading operations.

U.S. Pat. No. 5,618,150, issued Apr. 8, 1997, to Poindexter, entitled “Cargo Handling Assembly”, shows an early version of a cargo handling device which was intended to handle larger and bulkier items.

That cargo handling assembly shown in the Poindexter patent included a base frame capable of being mounted on the floor of an overland vehicle. A pair of extension members are individually borne by the base members. The extension members are moveable along a predetermined path of travel from a first, stowed position, to a second, deployed position. A pair of carriages are slidably borne by the individual extension members. The carriages are moveable along a path of travel from a first position, where the respective carriages are located in spaced relation relative to the distal end of the respective extension members, to a second position, where the carriages are located near the distal end of the respective extension members. A cargo support assembly having a top end is rotatably connected to each individual extension member at a single pivot point. The top end of the cargo support assembly is rotatably moveable along an arcuately shaped path of travel from a first position, where the cargo support assembly is disposed in spaced relation relative to the surface of the earth, to a second position, where the cargo support assembly is disposed in an orientation which facilitates the removal of cargo from the cargo support assembly.

Despite the improvements offered by the design shown in the Poindexter patent, a need continued to exist for further improvements in such lifting system designs.

For example, a need continued to exist for improvements in the pivot mechanism of the device which is used for pivoting the cargo support assembly from the above described first position to the second position, in order to more smoothly transfer the load from the vehicle to the ground.

A need also continued to exist for improved structural load carrying features for transferring the load from the base frame, slidable carriages and to the extension members.

A need also continued to exist for improvements in the nature of the cargo support assembly in order to more completely surround and protect the cargo being transported.

### SUMMARY OF THE INVENTION

Therefore, it is an object of present invention to provide an improved cargo handling assembly for overland vehicles and the like.

Another object of the invention is to provide a cargo handling assembly which is operable to handle bulky and delicate cargo, and which can be quickly installed in an overland vehicle without the necessity of undue modification of the vehicle.

Another object of the invention is to provide an improved lift assembly which increases the ease, and speed with which heavy cargo may be transported and delivered.

Another object of the invention is to provide such a lift assembly which incorporates a smoother pivoting action than did the prior art devices, thereby insuring a smoother path of travel of the cargo assembly as the assembly is being translated from a generally horizontal plane in the floor of the vehicle to a generally vertical plane on the surrounding support surface.

Another object of the invention is to provide such a lift assembly with a more heavy duty load transfer system for transferring the load between the base members, carriage members and extension arms of the system which is also quieter and free from rattles in the stored position and during transport.

Another object of the invention is to provide such a system with a more protective cargo handling enclosure for protecting delicate equipment and loads such as, for example, medical diagnostic equipment.

These objects of the invention are accomplished by providing a cargo handling assembly for a mobile vehicle having a cargo carrying region and a floor. The cargo handling assembly includes a base frame having a pair of parallel spaced rail members mounted on the floor of the vehicle which define a length for the base frame. A carriage assembly has a pair of spaced parallel extension arms each with an inner extent and an outer extent. An opposing wheel arrangement is mounted on each extension arm, each opposing wheel arrangement creating a opening for receiving a length of each parallel spaced rail member, whereby the carriage assembly is horizontally translatable along the length of the base frame by movement of the opposing wheels along the spaced rail members. A load cage is also provided for receiving and transporting cargo, the load cage having side elements and a base plate which together define an enclosed cage space for protecting cargo being transported. An actuator mechanism operatively connects carriage assembly and the load cage for rotating the load cage in an elliptical path about a pair of rotational axes which are substantially perpendicular to each outer extent of each extension arm between a first position, where the cage is disposed in a substantially horizontal position and lies in nested relation relative to the base frame, and a second position, in which the cage is disposed in a substantially vertical position with respect to a surrounding support surface.

Preferably, the actuator mechanism comprises an electric, hydraulic or winch cable system located between the carriage and a selected point on the cage side elements, movement of the actuator mechanism between an extended and retracted positions serving to rotate the load cage in the elliptical path about the rotational axes. In the preferred embodiment of the invention, the outer extents of the extension arms of the carriage assembly are connected to the upright elements of the load cage by a four-bar linkage arrangement which allows the load cage to approach the vertical position with the base plate in a more desirable position which is generally parallel to the surrounding support surface. Preferably, the load cage has a pair of spaced vertical upright elements and wherein each extension arm is connected to a selected one of the vertical upright elements by a pair of rigid linkage bars, a first linkage bar of relatively shorter length and a second linkage bar of relatively longer length running from the cage upright elements to each respective extension arm. The first and second linkage bars form a pair of pivot points on the outer extent of each extension arm as the load cage moves in the elliptical path about the rotational axes.

The carriage assembly further comprises a pair of guide blocks mounted on the carriage assembly which, together with the spaced rail members, enclose an upper wheel of each opposing wheel arrangement mounted on each extension arm of the carriage assembly. The base frame also further includes a drive system comprising a drive motor and an associated rotating ball screw or drive screw and nut, the ball screw being operatively connected to the carriage assembly through a ball nut, whereby actuation of the drive motor causes the ball nut to advance and retract along the ball screw to thereby provide linear movement of the carriage along the length of the parallel spaced rail members mounted on the floor of the vehicle.

At least selected ones of the spaced upright elements of the load cage are preferably telescopingly adjustable, whereby the enclosed cage space is adjustable for accommodating various sized loads being transported. In a particularly preferred embodiment of the invention, the spaced upright elements of the load cage form a six sided enclosed cage space for protecting the cargo being transported.

The load cage also provides a loading ramp means and a securing door on one side of the cage. The load ramp allows for uneven grade adaptation of the load cage and is secured in an upright or closed position by a combination ramp deployment and ramp latching arm.

In addition, a preferred embodiment of the load cage may have striker-load leveling wheels located at one edge of the load cage which act as a load bearing point in the vertically deployed configuration and which act as a method of taking up all of the mechanism tolerances to thereby substantially quieten the lift mechanism in the loaded, transportable configuration. In the loaded, transportable configuration of the device, the striker load wheels contact the base frame parallel spaced rail members.

Additional objects, features and advantages will be apparent in the written description which follows.

### BRIEF DESCRIPTION OF THE DRAWINGS

FIG. 1 is a perspective view of the specialized mobile equipment handling lift system of the invention shown as it would appear when located in the cargo area of the overland vehicle and showing the cover for the drive mechanism and the guide blocks for the carriage assembly in place.

FIG. 2 is a perspective view, similar to FIG. 1, but showing the drive mechanism cover and the guide blocks removed for ease of illustration of the component parts of the device.

FIG. 3 is a view similar to FIG. 2, but showing the operative configuration of the lift system as it begins to move from the stored to the extended position.

FIG. 4 is a view similar to FIG. 3, but showing the cargo handling cage of the assembly fully extended and resting upon the surrounding support surface.

FIG. 5 is an isolated view of portions of the base frame, extension arms and cargo handling cage with parts of the carriage assembly removed for ease of illustration.

FIG. 6 is an isolated view of the load support assembly of the lift system of the invention.

### DETAILED DESCRIPTION OF THE INVENTION

The cargo handling assembly of the present invention will now be described with reference to the accompanying drawings. The invention will be described in terms of its use with a mobile, overland vehicle such as a minivan, or standard-sized van of conventional design of the type having a cargo carrying region. However, it will be understood by those skilled in the art that the present cargo handling assembly could be utilized as well with other overland vehicles such as trucks, buses, and other similar vehicles.

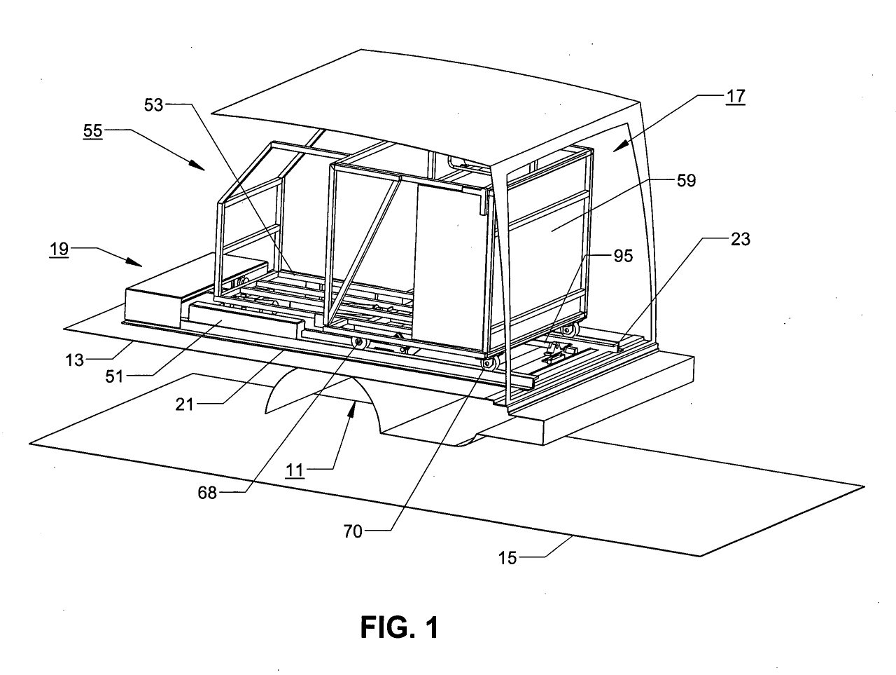

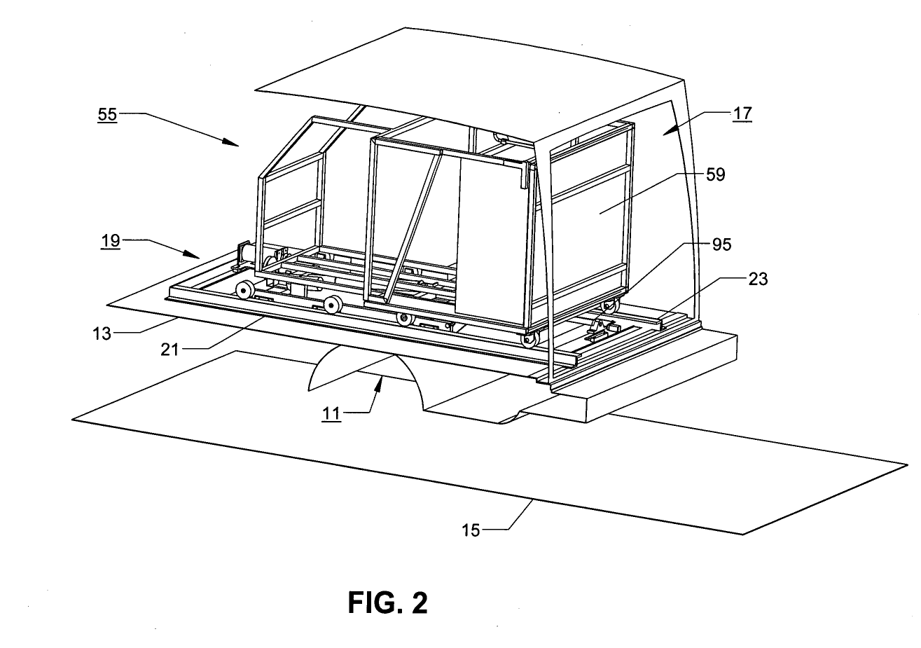

In FIGS. 1 and 2 of the drawings, only brief components parts of the conventional mobile vehicle are shown. Thus, there is shown an axle region 11 for containing earth engaging wheels and a floor region 13 which makes up the cargo carrying region of the vehicle. The floor region 13 is shown supported above the surrounding support surface 15, in this case the ground beneath the vehicle.

The typical overland vehicle has a pair of rear doors (not shown) which allow access to a cargo area which is defined by rear walls, the roof, and the floor region 13. Overland vehicles such as minivans, and standard-sized vans, when purchased as passenger vans, have floor mounts (not shown) which permit removable seating to be secured on the floor region 13. When the seating is removed, a cargo area is created which can receive relatively large or bulky cargo. As will be appreciated, the floor mounts (not shown) which are installed on the floor region 13 of the overland vehicle are positioned a given distance apart and these mounts are operable to secure the cargo handling apparatus 17 of the invention in a releasably fixed location within the cargo area of the van. The cargo handling assembly is secured to the individual mounts by employing fasteners and other similar assemblies which are well understood by those skilled in the art. Thus, the present assembly may be easily installed in a van of conventional design without any appreciable modification of the base vehicle.

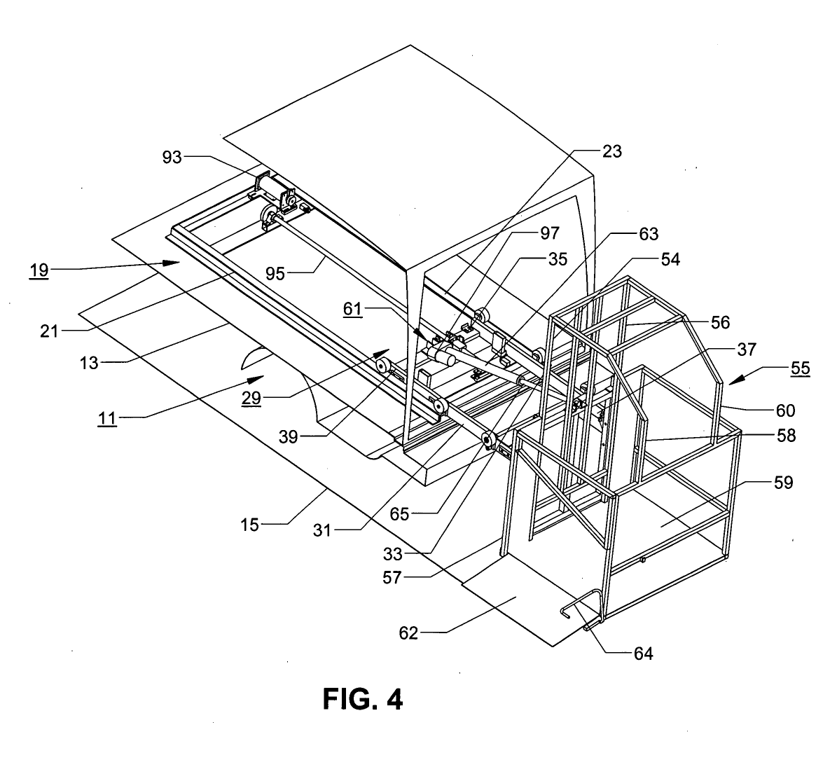

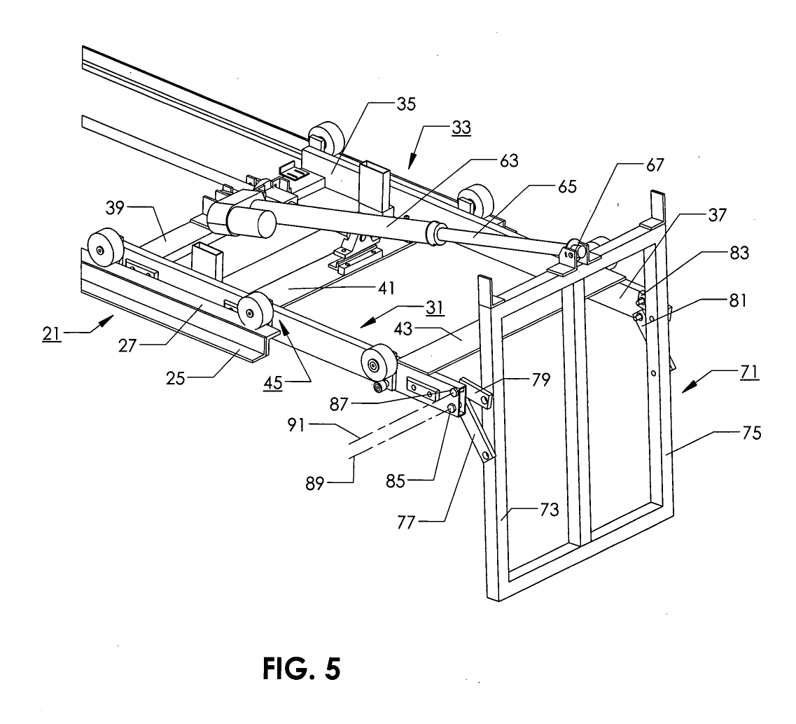

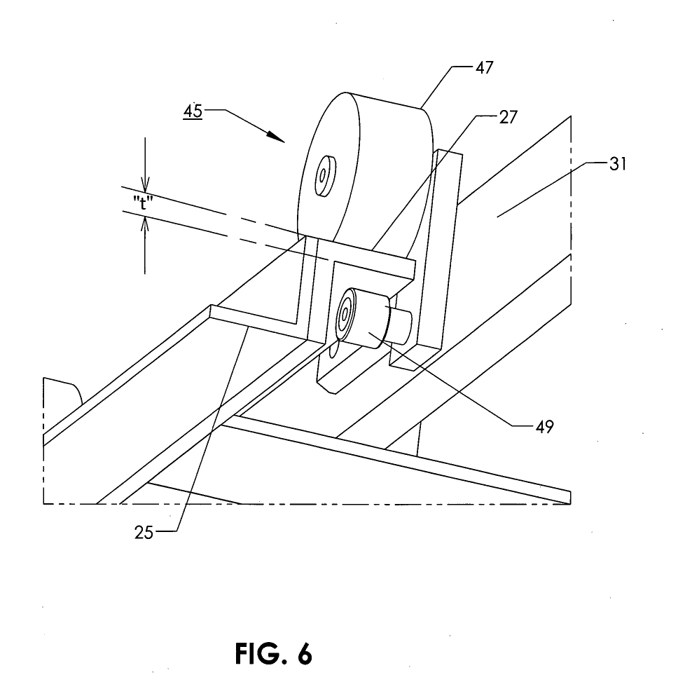

The cargo handling assembly 17 of the present invention includes a base frame which is generally indicated by the numeral 19 in FIGS. 1 and 2, and which can be releasably fixed, if desired, on the floor region 13 of the overland vehicle. The base frame 19 includes a pair of parallel spaced rail members 21, 23 which are mounted on the floor region 13 of the vehicle and which define a length for the base frame. With reference to FIG. 5, it can be seen that each rail member 21 includes a side angle portion 25 made up of two perpendicular arranged lengths of rail and a longitudinally extending track portion 27 which extends normal to the direction of the vertical portion of the length of rail as viewed in FIG. 4. The track portion 27 has a predetermined thickness “t” (see FIG. 6) for accommodating the opposing wheel arrangement of the carriage assembly, to be described.

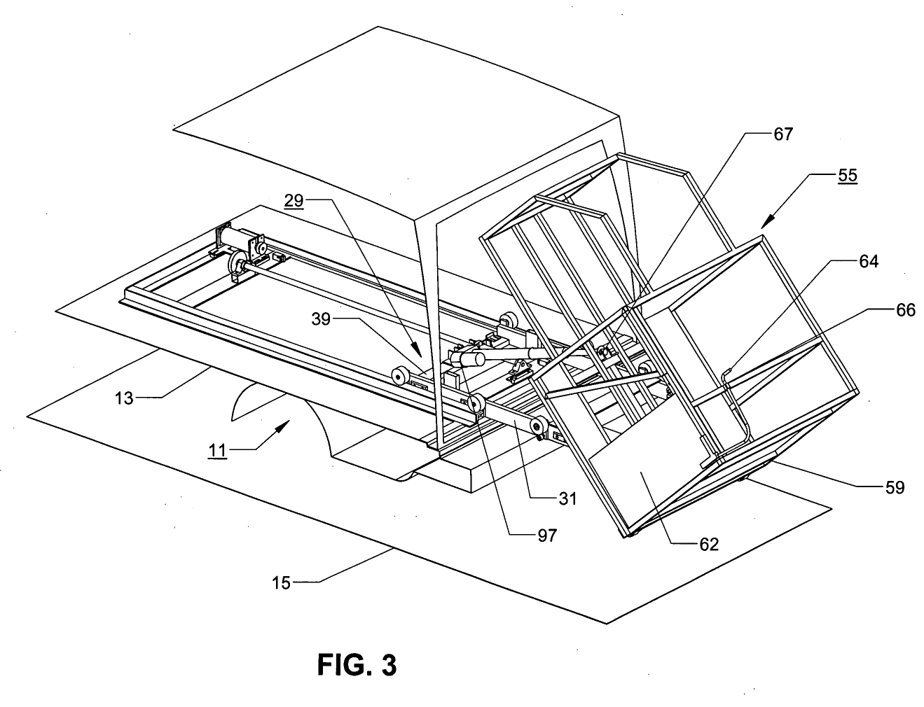

A horizontally translatable carriage assembly 29 (FIGS. 3 and 4) is slidably mounted on the base frame 19 and transmits loads via an opposing wheel arrangement affixed to the carriage. As shown in FIG. 5, the carriage assembly 29 has a pair of spaced parallel extension arms 31, 33 each with an inner extent 35 and an outer extent 37. The carriage also includes at least one transverse member 39 (FIG. 5) and preferably includes a plurality of such members (41, 43 in FIG. 5) which provides added structural integrity to the carriage assembly.

As best seen in FIGS. 5 and 6, an opposing wheel arrangement is mounted on each extension arm 31, 33. As best seen in FIG. 6, the opposing wheel arrangement 45 on each side of the carriage assembly includes a relatively larger diameter upper wheel 47 and a relatively smaller diameter lower wheel 49. Each opposing wheel arrangement creates an opening for receiving the track portion 27 of each parallel spaced rail member. As shown in FIG. 6, the opposing wheel set 45 captures the track portion 27 of each rail member allowing the carriage assembly 29 to move smoothly in a horizontal plane along the length of the rail assemblies. In this way, the carriage assembly 29 is horizontally translatable along the length of the base frame 19 by movement of the opposing wheels along the spaced rail members 21,23. The heavy duty upper wheel 47, along with the complimentary lower wheel 49, provide added stability and load carrying capability to the assembly. The opposing wheel arrangement is also quieter in operation and during transport since it does not tend to rattle or vibrate on the track 27.

As shown in FIG. 1, the carriage assembly 29 further comprises a pair of guide blocks 51, 53 mounted on the carriage assembly which, together with the spaced rail members, enclose the upper wheel of each of opposing wheel arrangement mounted on each extension arm of the carriage assembly. The guide blocks 51, 53 are longitudinally extending metal blocks which provide an upper enclosure or track for the upper wheels 47 of the opposing wheel arrangement of the carriage assembly. The guide blocks thus provide further stability and load supporting capability for the carriage assembly 29.

The cargo handling assembly also includes a load cage 55 for receiving and transporting cargo. The load cage (FIG. 4) has side elements 57 and a base plate 59 which together define and enclose cage space for protecting cargo being transported. The load cage 55 can be constructed of conventional metal tubing, either round, square or rectangular which may be fastened by welding or fasteners or as bent sections. The cage provides a flat base plate for wheeled or any other type loads. In the embodiment of the invention illustrated in FIG. 3, the cage surrounds the load on all six sides by structural elements. Pads and restraint systems may be used according to the type of load being transported and can be affixed to the cage by fasteners such as Velcro or restraining load straps. A latching door can be employed for securing the load within the cage. The vertical elements 54, 56, 58, 60 in FIG. 4 are also made up of mating channel members, one of which is telescopingly received within the other, whereby the enclosed cage space is adjustable for accommodating various sized loads being transported.

One preferred form of the latching door for the load cage is illustrated in FIG. 4. The panel illustrated as 62 provides a loading ramp means and a securing door on one side of the load cage 55. The loading ramp 62 allows for uneven grade adaptation of the load cage 55 and is secured in an upright or closed position by a combination ramp deployment and ramp latching arm 64. The loading ramp 62 is shown in the lowered position in FIG. 4 and in the closed and secured position in FIG. 3. Note that the latching arm 64 is held in the closed position by clamp means (66 in FIG. 3) located on the cage structural elements.

In addition, a preferred embodiment of the load cage 55 may have striker-load leveling wheels (illustrated as 68 and 70 in FIG. 1) located along one vertical element or edge of the load cage which act as load bearing points in the vertically deployed configuration and which act as a means for taking up all of the mechanism tolerances to thereby substantially quieten the lift mechanism in the loaded, transportable configuration. In the loaded, transportable configuration of the device, the striker load wheels 68, 70 contact the base frame parallel spaced rail members, such as rail member 21 in FIG. 1.

An actuator mechanism (61 in FIG. 4) operatively connects the carriage assembly 29 and the load cage 55 for rotating the load cage in a generally elliptical path about a pair of rotational axes which are substantially perpendicular to each outer extent 37 of each extension arm 31, 33. As can be seen in FIG. 4, the actuator mechanism 61 can comprise an electrically powered actuator 63 having an actuator arm 65 located between the carriage assembly 29 and a selected point (67 in FIG. 5) on the load cage 55. In the embodiment of the invention illustrated, the point 67 is actually located on a cross member 69 (FIG. 5) of an actuating frame 71 of the load cage. Since the distal end of the arm 63 is affixed to the transverse member 39 of the carriage assembly, movement of the arm 65 between an extended and retracted positions serves to rotate the load cage about a pivot axis. In this way, the load cage is actually moved between the positions illustrated in FIGS. 1-4 between a first position, where the cage is disposed in a substantially horizontal position and lies in nested relation relative to the base frame 19, and a second position, in which the cage is disposed in a substantially vertical position with respect to the surrounding support surface (FIG. 4). While the actuator mechanism 61 is illustrated as being powered by an electric motor in FIGS. 1-4, it will be understood that it could be powered by means of a hydraulic cylinder or by a winch/cable system, or other convenient means, as well.

The actual movement of the load cage is in an elliptical path which presents advantages over the prior art in providing a smoother transition between the first and second positions previously described for the load cage. The elliptical path of travel is achieved by employing a special four-bar linkage arrangement (see FIG. 5) which allows the load cage to approach the vertical position shown in FIG. 4 with the base plate 59 approximately parallel to the surrounding surface 15. As shown in FIG. 5, the actuating frame 71 of the load cage has a pair of spaced vertical upright elements 73, 75. Each extension arm 31, 33 is connected to a selected one of the vertical upright element 73, 75 by a pair of rigid linkage bars 77, 79, 81, 83. A first linkage bar 79 of relatively shorter length runs from the cage upright element 73 to an inside surface of the respective extension arm and a second linkage bar of a relatively longer length 77 runs from the cage upright elements 73 to the same inside surface of each respective extension arm (in this case 31). This arrangement actually creates a pair of pivot points (85, 87 in FIG. 5) on the outer extent of each extension arm 31 as the load cage 55 moves in the elliptical path about the rotational axes (such as axes 89, 91 in FIG. 5) drawn through the respective pivot points.

Returning to FIG. 4, the base frame 19 further includes a drive system for translating the carriage assembly 29 horizontally along the spaced rail members 21, 23. In the example illustrated, the drive system comprises an electric drive motor 93 and an associated rotating ball screw 95. The ball screw 95 is operatively connected to the carriage assembly 29 through a ball nut 97, whereby actuation of the drive motor 93 causes the ball nut to advance and retract along the ball screw 95 to thereby provide linear movement of the carriage assembly 29 along the length of the parallel spaced rail members 21, 23 mounted on the floor 13 of the vehicle. Although the ball screw and ball nut arrangement presents a convenient means for achieving horizontal translation of the carriage assembly, those skilled in the art will appreciate that this action could also have been achieved with hydraulic cylinders, or other types of conventional drive mechanisms.

The operation of the cargo handling assembly of the invention will now be described with reference to FIGS. 1-4. FIGS. 1 and 2 illustrate the assembly in the fully nested position as would it be seen during transport. At the loading location, the rear doors of the cargo van are opened and the drive motor 93 is actuated to start the linear movement of the carriage assembly 29 in the direction of the rear doors. Once the carriage assembly has reached the end of the rail members 21, 23, as indicated by an electronic limit switch or the like, the actuator mechanism 63 is actuated causing the actuator arm 65 to extend and causing the load cage to begin an elliptical path of movement about the pair of pivot points previously described. FIG. 4 shows the load cage in the fully extended position with the base plate 59 resting upon the surrounding support surface 15. While the initial use envisioned for the load cage is for transporting medical equipment such as ultra sound imaging devices, other loads such as x-ray equipment or diverse loads such as tool boxes, mail bags and packages, packaged containers or any other similar load capable of being inserted into the load cage can be transported by the device of the invention.

Control of the lift system of the invention requires the use of direct current power available from the vehicle which is being outfitted with the lift system. Use of direct current powered actuation motors requires polarity reversing to enable the actuation motors to drive the loads in opposite directions. In addition to driving the loads in opposite directions, it is desirable to utilize the actuation motors as braking or holding devices due to their inherent built-in magnetic fields. By applying the braking or holding feature the driven loads are secured in the “powered off” conditions of the lift system and thus stabilize the loads in a safe and secure manner.

To accomplish the polarity reversing and the application of the braking and holding actions of the actuation motor magnetic fields, a set of relays are utilized. One of these relays reverses the direct current set of connections to the actuation motors and the second relay applies a ground path to the open (or no power) set of connections of the actuation motors. A single control switch performs the appropriate logic for opening or closing the set of relay contacts of both relays.

One of the relays applies a ground path to the field coils of the actuation motors, preventing the armature of the actuation motor from rotating due to the magnetic field couple to the armature. By this rotation prevention, the actuation motor holds or stops the load movement. This application of grounding the magnetic field of the actuation motors is termed “dynamic braking”.

A further enhancement of the dynamic braking feature utilizes a capacitor and resistor in parallel and series respectively to the dynamic braking ground path to cause a selectable time delay to the ground path. This application of a delay prevents sudden stoppage of the actuation motor armature and subsequent high inertial loads from the driven loads of the lift system. This tailoring of the dynamic braking ground path allows the matching of the amount of dynamic braking to the driven load requirements. It also reduces the inertial loads on all of the mechanical lift drive components. Further it stabilizes and holds the driven loads in a safe position should the operator elect to stop the operation at some intermediate point of deployed or loaded state.

An invention has been provided with several advantages. The cargo handling assembly of the invention improves upon existing devices by the unique application of a four-bar linkage designed for more smoothly translating the position of the load cage between the fully nested position within the cargo area of a van and the fully extended position. The opposing wheel design of the carriage assembly provides additional stability to the design as well as additional load carrying capability. It is also quieter in operation and during transport. The four-bar linkages allows the load cage to approach the vertical position with the load cage base plate parallel to the ground, which is an improvement to the existing single point rotational designs of the prior art. The total operation of the load cage can be controlled from inside the motor vehicle with appropriate hydraulic and electrical control systems to allow the operator to control the operation with a single switch which causes the carriage drive system to perform a linear translation of the load cage from the van cargo region to a predetermined position to allow the structural cage to rotate to the vertical. Once in the vertical position, a load gate is opened on the cage to allow a load to be inserted or extracted from the cage. Padding and protective materials can be provided inside the cage to further protect the load. The length of the four-bar linkage arrangement can be adjusted to achieve different rotation effects. The cage surrounds the load on all six sides by structural elements, offering further protection to delicate loads.

While the invention has been shown in one of its forms, it is not thus limited but is susceptible to various changes and modifications without departing from the spirit thereof.

What is claimed is:

1. A cargo handling assembly for a mobile vehicle having a cargo carrying region and a floor, the cargo handling assembly comprising:
a base frame having a pair of parallel spaced rail members mounted on the floor of the vehicle which define a length for the base frame;
a carriage assembly mounted on the base frame, the carriage assembly having a pair of spaced parallel extension arms each with an inner extent and an outer extent; an opposing wheel arrangement mounted on each extension arm, each opposing wheel arrangement creating a opening for receiving a length of each parallel spaced rail member, whereby the carriage assembly is horizontally translatable along the length of the base frame by movement of the opposing wheels along the spaced rail members;
a load cage for receiving and transporting cargo, the load cage having side elements and a base plate which together define an enclosed cage space for protecting cargo being transported;
an actuator mechanism operatively connected between the carriage assembly and the load cage for rotating the load cage in an elliptical path about a rotational axis which is substantially perpendicular to each outer extent of each extension arm between a first position, where the cage is disposed in a substantially horizontal position and lies in nested relation relative to the base frame, and a second position, in which the cage is disposed in a substantially vertical position with respect to a surrounding support surface.

2. The cargo handling assembly of claim 1, wherein the actuator mechanism comprises an actuator arm located between the carriage and a selected point on the cage side elements, movement of the actuator arm between an extended and retracted positions serving to rotate the load cage in the elliptical path about the rotational axis.

3. The cargo handling assembly of claim 2, wherein the outer extent of each extension arm of the carriage assembly is connected to an upright element of the load cage by a four-bar linkage arrangement which allows the load cage to approach the vertical position with the base plate parallel to the surrounding support surface.

4. The cargo handling assembly of claim 3, wherein the load cage has a pair of spaced vertical upright elements and wherein each extension arm is connected to a selected one of the vertical upright elements by a pair of rigid linkage bars, a first linkage bar of relatively shorter length and a second linkage bar of relatively longer length running from the cage upright element to each respective extension arm.

5. The cargo handling assembly of claim 4, wherein the first and second linkage bars form a pair of pivot points on the outer extent of each extension arm as the load cage moves in the elliptical path about the rotational axis which is substantially perpendicular to each outer extent of each extension arm between the first position, where the cage is disposed in a substantially horizontal position and lies in nested relation relative to the base frame, and the second position, in which the cage is disposed in a substantially vertical position with respect to a surrounding support surface.

6. The cargo handling assembly of claim 5, wherein the carriage assembly further comprises a pair of guide blocks mounted on the carriage assembly which, together with the spaced rail members, enclose an upper wheel of each opposing wheel arrangement mounted on each extension arm of the carriage assembly.

7. The cargo handling assembly of claim 6, wherein the base frame further includes a drive system comprising a drive motor and an associated rotating ball screw, the ball screw being operatively connected to the carriage assembly through a ball nut, whereby actuation of the drive motor causes the ball nut to advance and retract along the ball screw to thereby provide linear movement of the carriage along the length of the parallel spaced rail members mounted on the floor of the vehicle.

8. The cargo handling assembly of claim 7, wherein at least selected ones of the spaced upright elements of the load cage are telescopingly adjustable, whereby the enclosed cage space is adjustable for accommodating various sized loads being transported.

9. The cargo handling assembly of claim 8, wherein the spaced upright elements of the load cage form a six sided enclosed cage space for protecting the cargo being transported.

10. The cargo handling assembly of claim 4, wherein the load cage has a side panel mounted thereon which forms a loading ramp for the cage when deployed between a closed and secured position and an extended position.

11. The cargo handling assembly of claim 10, wherein the side panel is pivoted between the closed and secured position and the extended position by means of a pivot arm.

12. The cargo handling assembly of claim 4, wherein the load cage is provided with striker wheels located on selected vertical upright elements thereof, the striker wheels being aligned with the base frame parallel spaced rail members when the cage is in the substantially horizontal position in nested relation relative to the base frame.

13. The cargo handling assembly of claim 4, wherein the movement of the cage between the horizontally nested position and the substantially vertical position is accomplished by direct current powered actuation motors which are powered by direct current power available from the vehicle, the actuation motors being controlled by a dynamic braking control system.

14. A cargo handling assembly for a mobile vehicle having a cargo carrying region and a floor, the cargo handling assembly comprising:
a base frame having a pair of parallel spaced rail members mounted on the floor of the vehicle which define a length for the base frame;
a carriage assembly having a pair of spaced parallel extension arms each with an inner extent and an outer extent;
an opposing wheel arrangement mounted on each extension arm, each opposing wheel arrangement creating a opening for receiving a length of each parallel spaced rail member, whereby the carriage assembly is horizontally translatable along the length of the base frame by movement of the opposing wheels along the spaced rail members;
a load cage for receiving and transporting cargo, the load cage having side elements and a base plate which together define an enclosed cage space for protecting cargo being transported;
an actuator mechanism operatively connected between the carriage assembly and the load cage for rotating the load cage in an elliptical path about a rotational axis which is substantially perpendicular to each outer extent of each extension arm between a first position, where the cage is disposed in a substantially horizontal position and lies in nested relation relative to the base frame, and a second position, in which the cage is disposed in a substantially vertical position with respect to a surrounding support surface;
wherein the load cage has a pair of spaced vertical upright elements and wherein each extension arm is connected to a selected one of the vertical upright elements by a first and second rigid linkage bars, the first and second linkage bars forming a pair of pivot points on the outer extent of each extension arm as the load cage moves in the elliptical path about the rotational axis which is substantially perpendicular to each outer extent of each extension arm.

15. The cargo handling assembly of claim 14, wherein the first linkage bar is of relatively shorter length and runs from the cage upright element to an inside surface of the respective extension arm and the second linkage bar is of relatively longer length and runs from the cage upright element to an outside surface of each respective extension arm.

16. The cargo handling assembly of claim 15, wherein the carriage assembly further comprises a pair of guide blocks mounted on the carriage assembly which, together with the spaced rail members, enclose an upper wheel of each opposing wheel arrangement mounted on each extension arm of the carriage assembly.

17. The cargo handling assembly of claim 16, wherein the base frame further includes a drive system comprising a drive motor and an associated rotating ball screw, the ball screw being operatively connected to the carriage assembly through a ball nut, whereby actuation of the drive motor causes the ball nut to advance and retract along the ball screw to thereby provide linear movement of the carriage along the length of the parallel spaced rail members mounted on the floor of the vehicle.
